(19) United States
(12) Patent Application Publication
(10) Pub. No.: US 2012/0177202 A1
(43) Pub. Date: Jul. 12, 2012

(54) SECURE TRANSPORT OF DOMAIN-SPECIFIC CRYPTOGRAPHIC STRUCTURES OVER GENERAL PURPOSE APPLICATION PROGRAM INTERFACES

(75) Inventors: John C. Dayka, New Paltz, NY (US); Michael J. Jordan, Hurley, NY (US); Tamas Visegrady, Zurich (CH)

(73) Assignee: INTERNATIONAL BUSINESS MACHINES CORPORATION, Armonk, NY (US)

(21) Appl. No.: 12/986,517

(22) Filed: Jan. 7, 2011

(51) Int. Cl. H04L 9/08

(52) U.S. Cl. 380/281

(57) ABSTRACT

A method of distributing cryptographic keys includes determining functional keys of domain-specific cryptographic service provider (DCSP); providing the functional keys to a fused cryptographic API (FCAPI) provided on a first computing device; encoding the functional keys with key encoding keys to produced encoded keys, the encoded keys including wrap or unwrap restrictions; receiving the encoded keys at a second computing device; unwrapping each encoded key until a first functional key is discovered, the first functional key having not including a wrap template; and providing the first functional key to the DCSP on at the computing device.

### BACKGROUND

The present invention relates to cryptography and, in particular, to secure transport of domain-specific cryptographic structures over general-purpose application program interfaces.

Some existing cryptographic application programming interfaces (APIs) are based on rigid, inflexible structures. For example, in the financial services industry, certain requirements are placed on which cryptographic keys may be used to encrypt what types of data. Such requirements may create problems when attempting to migrate or integrate these existing cryptographic API's with cryptographic systems having state-of-the-art key transport and management algorithms which may not observe the same strict restrictions. Indeed, the problems may be great enough that persons providing support to systems requiring cryptographic APIs may be forced to choose between supporting a legacy interface (and exploiting its fine-grained control mechanisms) or performing the difficult migration to a state-of-the-art API. In many cases, the need to balance between legacy compatibility, strict usage restrictions, and infrastructure-migration overhead forces prolonged coexistence of legacy solutions without a clear migration path.

Coexistence of legacy and state-of-the-art APIs may, however, create interoperability problems. For ease of explanation, legacy APIs that are domain-specific shall be referred to as DCSPs (domain-specific cryptographic service providers). DCSPs provide services for narrow fields, such as financial data processing, and are very restrictive and descriptive for particular applications. In contrast, general-purpose cryptographic service providers (GCSPs) are extensible, but they typically lack the fine-grained controls of DCSPs. Due to their extensibility, GCSPs allow faster integration of emerging technologies than DCSPs. For example, GCSPs allow for easy migration to stronger keys or additional algorithms.

One approach is to simply interface a DCSP with a GCSP. However, this may lead to key management problems that may arise to the characteristics of a particular DCSP. For example, DCSPs typically require strict key-typing hierarchies that combine key algorithms, strength, usage restrictions, and other attributes into a single “keytype.” That is, any change in any of these attributes will create a new keytype and, by implication, further complicate interactions with the typesystem.

DCSPs also define a rigid hierarchy of keytypes and, accordingly, inducing a new keytype is difficult. DCSPs may also include specific keytype usage restrictions related to the particular usage environment. For example, in financial data processing, certain keytypes may only be utilized to encrypt specific types of information (e.g., PIN numbers). Such domain-specific restrictions are typically of no interest to other applications, and, therefore, have no equivalent in GCSPs.

In addition, in DCSPs there may exist a tight binding between key attributes and key material, partially implied by the key hierarchy. Generally, a key object stores its encrypted key material and usage restrictions in a self-contained “token.” In some cases, token attributes may be modified or even manipulated, but “attribute-bound” (AB) objects are the norm in DCSPs.

Finally, while DCSPs may allow for relatively easy expansions to support operational key use, this expansion capability is typically restricted to functional keys and specifically excludes key transport keys, or key encoding keys (KEKs). Finally, DCSPs have little or no flexibility in extending the key hierarchy because such extensions would require the addition of other KEKs. Additional KEKs, of course, imply addition of new keytypes for any modifications.

Contrasting DCSPs with GCSPs, GCSPs usually enable addition of new algorithms and keytypes easily so long as they do not require new functionality classes. That is, it is simple to add new KEKs to a GCSP. For example, new encryption algorithms are typically added as new “mechanisms” of existing Encrypt and Decrypt functions, and rely on polymorphic use of existing interfaces. GCSP-using applications are typically are mandated to be able to use providers with different capabilities, and are not inconvenienced by needing to interrogate an attached GCSP before using it. In addition to adding new algorithms, GCSPs also enable adding attributes and other structures in a similar, future-compatible fashion. As long as standard functions, attributes, and other capabilities are available, the same GCSP may even host multiple types of applications, possibly with their own GCSP extensions, without the applications being aware of each other or even each other's custom extensions of the same GCSP.

### SUMMARY

According to one embodiment of the present invention, a method of distributing cryptographic keys is disclosed. The method of this embodiment includes determining functional keys of domain-specific cryptographic service provider (DCSP); providing the functional keys to a fused cryptographic API (FCAPI) provided on a first computing device; encoding the functional keys with key encoding keys to produced encoded keys, the encoded keys including wrap or unwrap restrictions; receiving the encoded keys at a second computing device; unwrapping each encoded key until a first functional key is discovered, the first functional key not including a wrap template; and providing the first functional key to the DCSP on at the computing device.

According to another embodiment of the present invention, a method of transporting keys of a domain-specific cryptographic service provider (DCSP) over a general cryptographic service provider (GCSP) is disclosed. The method of this embodiment includes generating functional keys in the DCSP; providing the functional keys to the GCSP; generating GCSP functional keys that are equivalent to the functional keys; encoding the GCSP functional keys in the GCSP with key encoding keys, wherein each key encoding key includes restrictions on the types of key encoding keys each key encoding key may encode.

According to another embodiment of the present invention, a method of distributing cryptographic keys is disclosed. The method of this embodiment includes receiving an encoded key at a computing device, the encoded key encoding at least a first functional key; unwrapping the encoded key in a general cryptographic service provider on the computing device until the first functional key is discovered, the first functional key not including a wrap template; and providing the first functional key to a domain-specific cryptographic service provider on the computing device.

According to another embodiment of the present invention, a computer program product for distributing keys of a domain-specific cryptographic service provider (DCSP) over a general cryptographic service provider (GCSP) is disclosed. The computer program product includes a computer readable storage medium having computer readable program code embodied therewith, the computer readable program code causing a computing device to perform a method comprising: generating functional keys in the DCSP; providing the functional keys to the GCSP; generating GCSP functional keys that are equivalent to the functional keys; and encoding the GCSP functional keys in the GCSP with key encoding keys, wherein each key encoding key includes restrictions on the types of key encoding keys each key encoding key may encode.

According to another embodiment of the present invention, a computer program product for distributing cryptographic keys is disclosed. The computer program product includes a computer readable storage medium having computer readable program code embodied therewith, the computer readable program code causing a computing device to perform a method comprising: receiving an encoded key at a computing device, the encoded key encoding at least a first functional key; unwrapping the encoded key in a general cryptographic service provider on the computing device until the first functional key is discovered, the first functional key not including a wrap template; and providing the first functional key to a domain-specific cryptographic service provider on the computing device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of processing system on which embodiments of the present invention may operate;

FIG. 2 shows a system according to one embodiment;

FIG. 3 shows an example of a key hierarchy; and

FIG. 4 shows a key hierarchy according to one embodiment of the present invention.

### DETAILED DESCRIPTION

As described above, given the ease of extensibility of a GCSP, it may be desirable to fuse a DCSP into a GCSP to form a fused system. Such fusion, however, may have inherent difficulties that, heretofore, have not been effectively overcome. The difficulties may arise from the fact that the fusion may require that the GCSP observe the same rigid key hierarchy and key usage restrictions as in the DCSP. In addition, the GCSP must observe restrictions on what KEKs are allowed to transport which types of information. However, typical GCSPs do not have the capabilities of enforcing such restrictions.

Accordingly, in one embodiment, systems and methods are provided for utilizing a GCSP in such a manner that it observes the KEK and functional key restrictions required by a particular DCSP. In a particular embodiment, the GCSP is PKCS#11 and the WRAP/UNWRAP_TEMPLATE attribute is utilized to limit the kinds of keys a particular KEK may process. Indeed, embodiments of the present invention take advantage of the realization that key management restrictions may be described by a few rules, such as allowing or disabling import/export, or restricting key-encryption to particular types of keys being transported. As such, according to one embodiment, the key management functions of a DCSP are disabled and all key management functions are handled by the GCSP. In such an embodiment, to signify that certain attributes have been set in the GCSP, the resultant system, including the set attributes, shall be referred to herein as a fused cryptographic API (FCAPI) to distinguish it from the GCSP on which it is based.

In one embodiment, supporting a small number of key management restrictions in a GCSP may allow the FCAPI to handle all DCSP access restrictions, even if many of them would not be understood by a GCSP. For example, if the DCSP object is functionally restricted, it may be a domain-specific restriction the GCSP cannot describe (without adding extended attributes for that restriction). These restrictions are therefore encoded within the FCAPI object in a non-separable way, and restrict use even if the object is accessed directly through GCSP calls (as opposed to the system emulating the DCSP over tunneling calls).

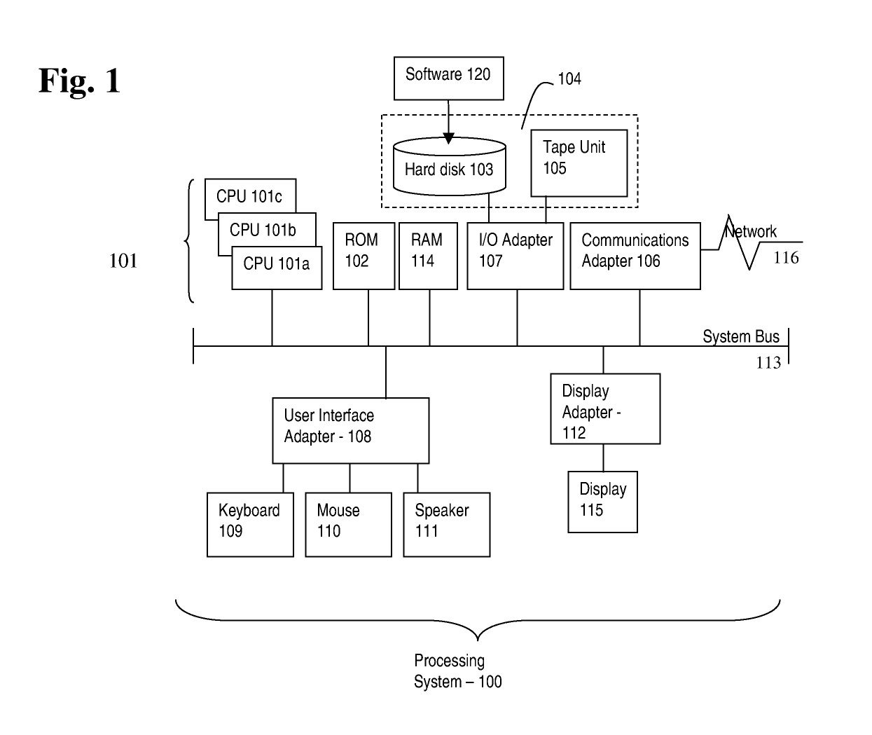

FIG. 1 shows an example of a computing system on which embodiments of the present invention may be implemented. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O buses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108. A keyboard 109, mouse 110, and speaker 111 are all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device. It shall be understood that the system 100 may include multiple computing devices linked together by a communication network. For example, there may exist a client-server relationship between two systems and processing may be split between the two.

Examples of operating systems that may be supported by the system 100 include Windows 95, Windows 98, Windows NT 4.0, Windows XP, Windows 2000, Windows CE, Windows Vista, Mac OS, Java, AIX, z/OS, Linux, and UNIX, or any other suitable operating system. As noted above, the system 100 also includes a network interface 106 for communicating over a network 116. The network 116 can be a local-area network (LAN), a metro-area network (MAN), or wide-area network (WAN), such as the Internet or World Wide Web.

Users of the system 100 can connect to the network 116 through any suitable network interface connection, such as standard telephone lines, digital subscriber line, LAN or WAN links (e.g., T1, T3), broadband connections (Frame Relay, ATM), and wireless connections (e.g., 802.11a, 802.11b, 802.11g or 802.11n).

As disclosed herein, the system 100 includes machine-readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. The software 120 may include various tools and features for providing user interaction capabilities as are known in the art.

In some embodiments, the software 120 is provided as an overlay to another program. For example, the software 120 may be provided as an “add-in” to an application (or operating system). Note that the term “add-in” generally refers to supplemental program code as is known in the art. In such embodiments, the software 120 may replace structures or objects of the application or operating system with which it cooperates.

In one embodiment, the software may include one or both of a DCSP and an FCAPI. The DCSP and the FCAPI provide cryptographic protection to communications sent from the system to any other system.

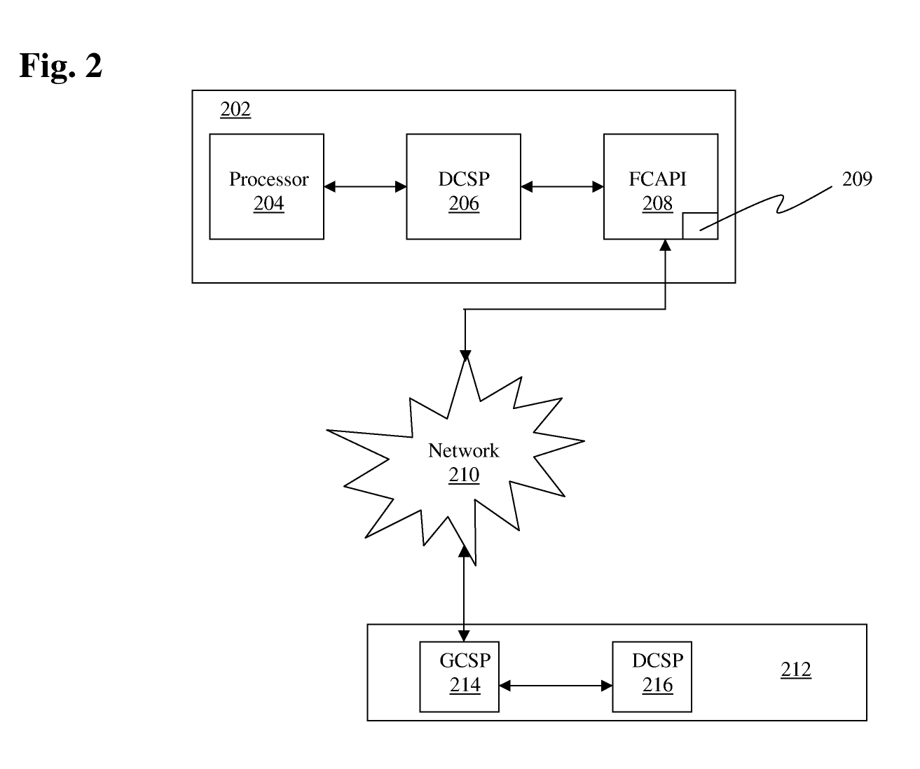

FIG. 2 shows an example of system 200 according to one embodiment of the present invention. The system 200 includes a first computing device 202. The first computing device 202 may, for example, be a computing system as shown in FIG. 1. In one embodiment, the first computing device 202 is an ATM. The first computing device 202 may include a processor 204. The processor 204 communicates through and is coupled to a DCSP 206.

The DCSP 206 may be a domain-specific cryptographic API in one embodiment. The DCSP 206 may include one or more restrictions on key usage and key management. The DCSP 206 may be coupled to an FCAPI 208. In one embodiment, the FCAPI 208 handles all key management and is based off of an existing GCSP.

For key management communications, the FCAPI 208 is coupled to a network 210. Through the network 210 the first computing device 202 may communicate with a second computing device 212. The second computing device 214 may include a GCSP 214.

The FCAPI 208 may include a key management model 209. The key management model 209 applies to KEKs. In one embodiment, each KEK in the key management model 209 includes at least one key encoding capability. These capabilities may include, for example, the ability to wrap or unwrap another key and may be limited by the type of key it may wrap or unwrap. Any key that does not have an encoding capability shall be referred to herein as a “functional key.”

In one embodiment, the key management model 209 may be utilized to transport DCSP keys by representing them with a corresponding set of FCAPI key management keys. The FCAPI key management keys may, in one embodiment, include stronger keys or algorithms than the DCSP 206 provides.

In one embodiment, the FCAPI 208 handles all key management. The KEKs used by the FCAPI 208 may include usage restrictions that allow the KEKs to only process certain other KEKs. The restrictions may be stored in the key management model 209 in one embodiment. The restrictions may be created based on knowledge of the DCSP 206, for example.

In one embodiment, a KEK may be created in the FCAPI 209 that includes no processing abilities. Any KEK so defined shall be understood by an FCAPI that receives such a KEK as a functional key that is to be passed to the DCSP. To that end, the second computing device 212 may include a second FCAPI 214 and a second DSCP 216. The second DCSP 216 may be the same as the first DCSP 206 in one embodiment.

The following description of modifications to a GCSP to create the FCAPI 208 assumes that the GCSP is an extensible GCSP and that the particular specifications of the first DCSP 206 are known. In one embodiment, the GCSP may be PKCS#11. Of course, other GCSPs may be utilized as long as they are modified as described herein. It shall be understood that only a small number of GCSP extensions are needed (and rules on how to combine them) to represent a small set of DCSP attributes in the FCAPI 208. The attributes may include whether or not a key may be exported in encrypted form and the native keytype of a key. Such fundamental attributes are available in all cryptographic service providers (CSPs), and therefore need straightforward translation, but do not require additional functionality.

In order to observe the DCSP key hierarchy, the first FCAPI 208 may include restrictions on what particular KEKs may transport. Restrictions on what a KEK may transport are, therefore, encoded as attributes within the KEK, and enforced by the FCAPI 208 before transmission of a KEK from, for example, the first computing device 202 to the second computing device 212. In one embodiment, the capability to restrict KEK usage may be added as an extension to the GCSP if the GCSP does not provide it. In the event that the DCSP 204 does not map one-to-one into classes of the GCSP, “meta-types” may be added and referenced in, for example, usage restrictions. For example, if the DCSP 206 includes an abstract “key class” for certain dissimilar keys (say, RSA and symmetric keys, which are otherwise radically different object types), the FCAPI 208 may include an aggregation category as a custom key type. Adding such an extended attribute may allow the FCAPI 208 to designate objects of this class through a single, standard attribute query.

While completely generic KEK-usage restrictions are a possibility, in one embodiment, equivalent restrictions may be implemented by a single level of KEK attributes, which then apply recursively. Any DCSP key hierarchy then maps into a specific set of KEK-usage restrictions, which are enforced by slightly extended GCSP services.

In one embodiment, because the KEKs of the FCAPI 208 observe type restrictions from the DCSP 206, the FCAPI 208 does not violate any KEK-usage rules, or violate the keytype-hierarchy. To prevent separation of attributes and key material, the FCAPI 208 may be extended with an algorithm which binds (possibly cryptographically) attributes to key material. Such binding may be performed, for example, by the key management model 209. In one embodiment, such a standardized, attribute-bound format may be added as a simple extension of typical Wrap and Unwrap services (i.e., key transport). Accordingly, in one embodiment, attribute-binding (AB) is an extended attribute for KEKs in the FCAPI 208.

To maintain proper separation, AB keys would only interact with other AB keys during key management. For example, non-AB keys would not be able to transport AB keys. This may include, for example, transitioning GCSP objects into AB and non-AB key domains, and using them behind the same polymorphic API. As long as these restrictions are enforced, a DCSP requirement on never separating attributes from keys would be observed.

While in transport form, encrypted under a FCAPI KEK, objects do not have any functional GCSP attributes set, apart from key import or export (as applicable). In one embodiment all functional services such as encryption or signature generation are disallowed. This may prevent functional use before a particular object has been imported into a DCSP. By implication, this ensures that no DCSP usage restrictions are violated, even while the object is transported by the FCAPI 208.

When finishing key management, such as moving the encrypted key into second computing device 212, a service may be provided that reconstructs the DCSP key from a FCAPI key. Depending on the implementation, functional knowledge of key objects may be combined with DCSP attributes retrieved from extended GCSP ones. In the latter case, the base extended attributes would need to be stored at object construction.

After keys have been exported into DCSP form by the second GCSP 214 they are further handled exclusively by the second DCSP 216.

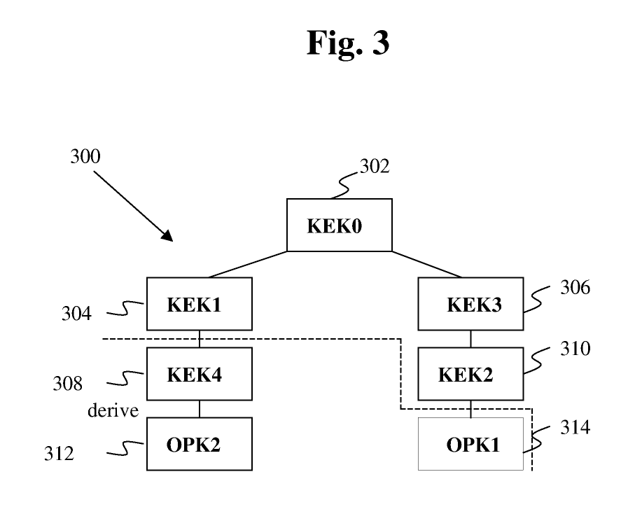

FIG. 3 shows an example a DCSP key hierarchy 300. In this example, the key hierarchy has a top level key KEK0 302. In this hierarchy, KEK0 302 is allowed to operate on (wrap or unwrap) KEK1 304 and KEK3 306. Similarly, KEK1 304 may operate on KEK4 308, and KEK3 306 may operate on KEK2 310. In the example shown, KEK4 308 may not be a true KEK, but rather is a function, such as a hash function, the application of which to KEK1 304 may produce a functional another key (OPK2 312). In this example, OPK2 312 and OPK1 314 are functional keys. Accordingly, KEK4 308, OPK2 312 and OPK1 316 shall collectively be referred to as “functional keys.” As discussed above, the functional keys may not be used to process KEKs in one embodiment.

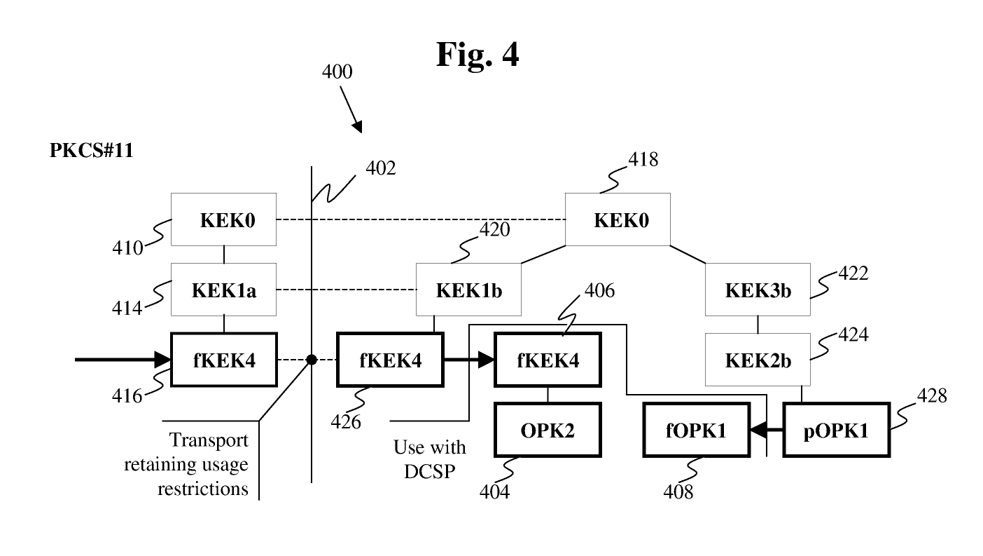

FIG. 4 shows an example of a key hierarchy 400 according to an embodiment of the present invention. In particular, the key hierarchy allows for native DCSP keys (e.g., keys 404, 406 and 408) to be transported by a GCSP. In this example, the GCSP is PKCS#11.

As will be discussed in greater detail below, the GCSP has been configured to be a FCAPI according to the present invention. That is, during transport, the FCAPI ensures that the DCSP keys 404, 406, and 408 do not exceed any limitations placed on them by the DCSP. For example, in one embodiment, the DCSP keys 404, 406 and 408 may not be allowed to encode any other keys. Accordingly, no violations of the native DCSP key limitations may occur.

In FIG. 4 KEKs (generally, only used with PKCS#11) and functional keys (only used within the DCSP) are used together. Certain keys will be used in both FCAPI (based off of PKCS#11 with certain attributes applied) and DCSP form. In FIG. 4, each key may have an import/export equivalent. Accordingly, keys to the right of transport line 402 are export keys and to the left of transport line are import keys.

In FIG. 4, keys 410, 414, 416, 418, 420, 422, 424, 426, and 428 are used within the FCAPI. Likewise, keys 404, 406 and 408 are used in the DCSP. In addition, some keys have representations in both the FCAPI and the DCSP. These keys include keys 416, 426, 406, 408 and 428. For these keys where equivalent representations of the same key material appear, they are prefixed with a letter designating their form. In the example, dOPK1 408 is a native operational key and “fOPK1” is its FCAPI (e.g., PKCS#11) form.

Considering again the key hierarchy of FIG. 3, most KEKs may be replaced completely by their FCAPI equivalents. The only exception, KEK4 408, is used to derive a key (OPK2) using an algorithm not supported by PKSC#11. Therefore, the KEK that needs to be represented in DCSP form is KEK4 308. It is assumed that the key hierarchy is to be strictly typed, i.e., these KEKs do not interact with other key types, and they can only transport keys directly beneath them in the hierarchy.

To restrict potential uses of a key, the PKCS#11 WRAP_TEMPLATE may be utilized. This attribute allows the KEK to process only certain kinds of keys. In this example, each KEK carries an UN/WRAP_TEMPLATE strictly restricting their use. For example, Table 1 illustrates limitations that may be applied to the KEKs in FIG. 4.

TABLE 1

| | | | WRAP_TEM- | Native | |
|---|---|---|---|---|---|
| Keytype | Wrap | Unwrap | PLATE | use? | NOTES |
| KEK0 | + | + | KEK1 or | | template restricts |
| | | | KEK3 | | type, possibly also |
| | | | | | size, of transported |
| | | | | | key |
| KEK1a | + | | KEK4 | | |
| KEK1b | | + | KEK4 | | |
| KEK3b | | + | KEK2 | | |
| KEK2b | | + | OPK1 | | |
| fKEK4 | | | N/A | | non-functional in |
| | | | | | PKCS#11 form; |
| | | | | | see dKEK4 |
| dKEK4 | N/A | N/A | N/A | + | native control |
| | | | | | restricts usage |
| fOPK1 | | | N/A | | non-functional in |
| | | | | | PKCS#11 form; |
| | | | | | see dOPK1 |
| dOPK1 | N/A | N/A | N/A | + | native control |
| | | | | | restricts usage |
| OPK2 | N/A | N/A | N/A | + | native control |
| | | | | | restricts usage |

In more detail, the master KEK (KEK0) and most transport keys are present only in FCAPI form. Since these keys use algorithms beyond typical DCSP capabilities, they need not be represented in native form, and are managed entirely using FCAPI (e.g., PKCS#11) services. Further, in FIG. 4 it shall be understood that KEK1a 414 and KEK1b 420 are the import-export equivalents of the same key, both transported under the same KEK0 (shown as KEK0 410 and KEK0 418). This may allow intermediate keys to be asymmetric keys (RSA) and, therefore, KEK1a 414 and KEK1b 420 may be different parts of the same keypair. Furthermore, because the KEK hierarchy is used only within the FCAPI, a single pair of polymorphic import/export services (Un/WrapKey) are used, regardless of KEK type. Unlike many native providers, PKCS#11 provides a single polymorphic Un/Wrap service pair, and selects sub-variants based on key/KEK types. Further, all keys are flagged to allow only AB transport, i.e., they may not be used by regular PKCS#11 objects for key import or export. Because all keys are attribute-bound, they may not be exported or compromised by regular PKCS#11 objects.

Keys destined to be exported to native form (e.g. fKEK4 426) are generated with customized PKCS#11 calls. For example, fKEK4 426 is generated such that it includes and encodes usage restrictions such as, for example, having no functional capabilities. In addition, the KEKs may only perform only Un/Wrap functions. Accordingly, they never violate operational restrictions of native keys, such as not generating message authentication codes (MACs) for verify-only keys, as these keys are not functionally used in their PKCS#11 form. Keys having no functional capabilities may be provided directly to the DCSP.

In the example of FIG. 4, assuming fOPK1 428 is a native MAC-generation key, it would not have its CKA SIGN attribute set, and therefore would not be allowed to generate MACs while in PKCS#11 form. Accordingly, it is passed (as dOKPK1) to a DCSP. As a special case, PKCS#11 could be user to transform operations with operational keys (OPKs) if those overlap with that of the native CSP, or provide algorithms that the native CSP does not.

By restricting the key type a KEK may un/wrap through the standard PKCS#11 UN/WRAP_TEMPLATE attribute, embodiments the FCAPI of the present invention may effectively implement a fixed key hierarchy, preventing misuse of keys up to the desired level (i.e., they form a rigid keytype-hierarchy like a DCSP would).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1-12. (canceled)

13. A computer program product for distributing keys of a domain-specific cryptographic service provider (DCSP) over a general cryptographic service provider (GCSP), the computer program product comprising:
a computer readable storage medium having computer readable program code embodied therewith, the computer readable program code causing a computing device to perform a method comprising:
generating functional keys in the DCSP;
providing the functional keys to the GCSP;
generating GCSP functional keys that are equivalent to the functional keys; and
encoding the GCSP functional keys in the GCSP with key encoding keys, wherein each key encoding key includes restrictions on the types of key encoding keys each key encoding key may encode.

14. The computer program product of claim 13, wherein the GSCP functional keys do not include attributes allowing them to encode any other key.

15. A computer program product for distributing cryptographic keys, the computer program product comprising:
a computer readable storage medium having computer readable program code embodied therewith, the computer readable program code causing a computing device to perform a method comprising:
receiving an encoded key at a computing device, the encoded key encoding at least a first functional key;
unwrapping the encoded key in a general cryptographic service provider on the computing device until the first functional key is discovered, the first functional key not including a wrap template; and
providing the first functional key to a domain-specific cryptographic service provider on the computing device.

16. The computer program product claim 9, wherein the first functional key encodes specific types of information.

17. The computer program product of claim 9, wherein the first functional key encodes message authentication codes (MACs).

18. The computer program product of claim 9, wherein the first functional key is not authorized to wrap any other key.
